(19) United States
(12) Patent Application Publication
(10) Pub. No.: US 2018/0099447 A1
(43) Pub. Date: Apr. 12, 2018

(54) SCREW TO BE USED IN AN EXTRUDER AND EXTRUDER

(71) Applicant: Reifenhäuser GmbH & Co. KG Maschinenfabrik, Troisdorf (DE)

(72) Inventor: Helmut MEYER, Troisdorf (DE)

(21) Appl. No.: 15/703,742

(22) Filed: Sep. 13, 2017

(30) Foreign Application Priority Data
Oct. 10, 2016 (DE) 10 2016 011 978.0

(51) Int. Cl. B29C 47/08

(52) U.S. Cl. CPC B29C 47/0844; B29C 47/6006

(57) ABSTRACT

A screw used in an extruder and an extruder having such a screw, in particular a screw used in a multiple-screw extruder and a multiple-screw extruder uses an additional connecting element directly leading from one segment to the next in order to relieve the mandrel. The screw includes a mandrel and a plurality of segments borne by the mandrel and arranged axially with respect to one another, a segment border between a first segment and an axially adjacent second segment has a separate cylindrical connecting element adapted to transmit a torque over the segment border. The ratio of a length of the connecting element to the diameter of the connecting element is higher than 11.

### CROSS REFERENCE TO RELATED APPLICATIONS

This application is related to and claims the benefit of German Patent Application No. DE 10 2016 011 978.0, filed on Oct. 10, 2016, the contents of which are herein incorporated by reference in their entirety.

### TECHNICAL FIELD

The disclosure refers to a screw to be used in an extruder and to an extruder having such a screw, in particular a screw to be used in a multiple-screw extruder and a multiple-screw extruder, the screw having a mandrel and a plurality of segments borne by the mandrel and arranged axially to one another.

### BACKGROUND

Normally, screws have a modular structure; in this manner, they can be adapted to new tasks and product properties in a very flexible manner. The modular structure of a screw leads to a rod-shaped core, called “mandrel” or in praxi often also called drive shaft or spindle, and individual screw components which are slid onto the mandrel. The screw components perform the classic functions of the screw in the extrusion process, such as, for instance, conveying, kneading, mixing or shearing the plastic being guided into and through the plant.

For transmitting the high torque that is produced, the components are brought into form-fitting engagement with the mandrel and are braced axially in addition.

DE 10 2008 028 289 A1 discloses a screw wherein the torque is transmitted from one segment to the next by means of toothing on their faces.

DE 103 30 530 A1 describes a shaft onto which a sleeve is welded. The segments are threaded onto the shaft up to the stopping point.

DE 10 2011 112 148 A1, DE 10 2004 042 746 B4 and DE 196 21 571 C2 each disclose specific types of toothing between the screw segments and the mandrel.

DE 37 14 506 A1 describes a form-fitting coupling at the faces of two shaft segments with circular bolts for connecting the shafts.

DE 43 19 058 A1 describes a smooth shaft with a circular cross-section as a carrier for the screw segments which are mutually connected by positive engagement at their front faces, wherein no connecting elements are used but instead the segments are axially braced with respect to each other.

EP 0 688 600 A1 describes a coupling of two shaft segments with circular bolts as connecting elements, which segments are connected at their front faces. Further, a segmented screw is described whose segments are slid onto a mandrel and have a protrusion on their front faces which engages a matching recess in the corresponding front face of the adjacent segment.

DE 44 44 370 A1 describes segmented screw, which is coupled by way of separate sleeves with annular cross-sections at the front faces of the segments.

JP 2009078361 A discloses a segmented screw wherein the segments are slid onto a mandrel and have a protrusion on their respective front face which engages a matching recess in the corresponding front face of the adjacent segment. That is, the segments are coupled by way of carriers on their front faces.

US 2012/0135098 A1 discloses a segmented screw whose segments are slid onto a mandrel and coupled at a front face by means of a special feather key whose longitudinal axis is curved such that it extends on the respective coupling reference circle.

### SUMMARY

The disclosure is based on the task of providing an improvement or an alternative to the state of the art.

In a first aspect of the disclosure, the task is solved by a screw to be used in an extruder, the screw having a mandrel and a plurality of segments borne by the mandrel and arranged axially to one another, wherein a segment border between a first segment and an axially adjacent second segment has a separate, in particular cylindrical connecting element adapted to transmit a torque over the segment border, a ratio of the length of the connecting element to the diameter of the connecting element being higher than 11.

Some terminology will be explained in the following:

First it is explicitly pointed out that within the context of the present patent application, indefinite articles and numerals such as “one”, “two” etc. are normally to be understood as indicating a minimum, that is, “at least one . . . ”, “at least two . . . ” etc., unless it is clear from the context or is obvious to the person skilled in the art or indispensable from a technical point of view that only “exactly one . . . ”, “exactly two . . . ” etc. are intended.

The “mandrel” is to be understood as extending, in any case, from the end of the first segment to the beginning of the last segment, in the axial direction. Application of the torque on the screw is possible both via the mandrel—in this case, a tangential fixation between the gear drive pinion and the mandrel is necessary—and via a connection of the gear drive pinion to at least one segment, preferably to the first segment in the axial direction, which connection transmits the torque.

The “segments” are those components of the screw which together form the spiral or the plurality of spirals for plastification of the plastic to be guided through the extruder in cooperation with the housing/cylinder of the extruder, and/or which form a kneading element and/or a conveying element.

Every two axially adjacent segments axially abut against each other at their segment borders, either directly, in the case of directly adjacent segments—or indirectly, in the case of one or more segments between them. The slot produced between them, that is, in the simplest case, an annulus, must be sealed against the penetration of plastic melt towards the inside, that is, towards the mandrel. The segments are normally braced axially for this purpose. The normal force causes sufficient sealing by surface pressure.

A “connecting element” is to be understood as a connection between the segments. In particular, a connecting element is suitable for limiting the radial and/or tangential movement of a segment. In an “angular” connecting element, the word “angular” refers to the cross-section of the connecting element which is oriented normally to the axis of the extruder.

The “connecting element” must cooperate both with the first segment and with the second segment. If a torque is applied to the screw, specifically to a segment, the first segment transmits at least the major part of the torque to the connecting element. The connecting element then forwards the torque to the—in particular axially adjacent—second segment with reference to the axis of the extruder.

To facilitate the assembly, the connecting element can be attached to a segment so that it can be released in a nondestructive manner. For instance, it is conceivable for the connecting element to be attached to the inside of a segment by means of a press fit or a close sliding fit. Then, when the screw gets assembled, the segment only needs to be threaded onto the mandrel with the connecting element already attached to it. If several such segments are threaded serially which already have a connecting element attached to them each on the same side, the screw is assembled automatically.

Alternatively, the connecting element can be separate from the two segments it connects.

In a particularly simple embodiment, the connecting element can be a ball.

In this case, the connecting element itself is neither integral with the first nor with the second segment, but a separate component of the assembled screw.

In the transition area from a first segment to a second segment, the connecting element can include several parts or only of one part.

The screw according to the disclosure, however, should have a plurality of adjacent segments with a connecting element. In other words, a plurality of segment borders between two segments each, in particular axially adjacent segments, are to be bridged by a connecting element. It is also possible for one connecting element to transmit the torque from one segment to the next even for a plurality of segment borders to be bridged. A preferred embodiment, however, provides for one connecting element to transmit only the torque of one segment border transition.

Advantageously, the aspect of the disclosure which is proposed here achieves a torque transition between screw segments in the field of extruders, that is, single-screw and multiple-screw extruders, where the strains on the mandrel, which are partly very high and comprise torsion, traction, pressure and flection, are reduced. The danger of mechanical failure of the mandrel is therefore substantially reduced as well. In addition, less expensive rods, ideally smooth cylindrical rods, can be used for the mandrel which in addition increases availability and resistance to mechanical stresses on the shafts.

In the solution worked out, the stresses are separated. The screw segment itself takes over the task of transmitting the torque. For this purpose, a new connecting element is inserted which is connected to at least two screw segments and which assumes the task of transmitting the torque of one screw segment to the next one. The torque transmitted between the segments is no longer transmitted via the screw mandrel. The screw mandrel remains without torque. In the science of the strength of materials, one speaks of a separation between torsional stress and direct stress. The novel screw mandrel (tension rod) has a smaller diameter and is “smooth” on the outside. The notch factor is therefore close to “1”, which again increases the permissible stress in the segment area.

A specific embodiment uses a cylindrical connecting element which has a length of at least eleven times that of its diameter. This comparatively large ratio of length to diameter is selected in order to reduce the bearing stress effects.

One advantage of the disclosure is the simplicity of the solution how the torque is transmitted via an additional connecting element and how the transmission of stresses is distributed over different components. This solution is very inexpensive because the connecting elements are commercially available as rod material (bulk goods).

The length of the connecting elements can further ensure that the surface pressure from the bearing stress is small enough.

Optionally, the segment has a blind hole, with the connecting element being inserted in the blind hole with positive engagement.

Advantageously, in this manner, the blind hole can be used to determine the insertion depth of the connecting elements. In this manner, it can be achieved that a connecting element is inserted in two adjacent segments, in the assembled state, to approximately the same depth. Consequently, the blind hole can help that the effects of bearing stress are about the same in the two neighboring segments.

Preferably, the ratio of the screw root diameter to the diameter of the connecting element ranges between 4 and 9, preferably between 5 and 8 and especially preferably between 6 and 7.

A “screw root” is the inner contact surface, seen radially, between the material to be processed and the screw. It can designate the bottom of a screw segment or the outer diameter of the screw mandrel.

Advantageously, in this manner, an optimal compromise in terms of construction can be achieved, for transmission of the torque, between the shearing stress applied on the connecting element and the bearing stress applied on the segment.

It is explicitly pointed out that the above-mentioned range limits of the ratio of screw root diameter to connecting element diameter are not to be understood as strict limits but can be higher or lower than indicated, on an engineering scale, without leaving the described aspect of the disclosure. In other words, the range limits are intended to form points of reference for the embodiment of a connection between adjacent segments.

In a second aspect of the disclosure, the task is solved by a screw to be used in an extruder, the screw having a mandrel and a plurality of segments borne on the mandrel and arranged axially with respect to one another, a segment border between a first segment and an axially adjacent second segment having a separate angular connecting element which is adapted to transfer a torque over the segment border, wherein in the assembled state a radial extension of the connecting element is larger than or equal to an extension in the circumferential direction.

A “radial extension of the connecting element” is understood as the spatial extension of the connecting element in the radial direction, starting from the axis of the extruder.

An “extension of the connecting element in the circumferential direction” is understood as the spatial extension of the connecting element in the circumferential direction, starting from the axis of the extruder.

Advantageously, the proposed aspect of the disclosure achieves a torque transmission with the use of screw segments in the field of extruders, that is, single-screw extruders and multiple-screw extruders, wherein the stresses on the mandrel known from the state of the art, which are partly very high and comprise torsion, traction, pressure and flection, are relieved. In this manner, the danger of a mechanical failure of the mandrel is substantially reduced. In addition, less expensive rods, ideally smooth cylindrical rods, can be used for the mandrel, which in addition increases availability and resistance to mechanical stresses on the shafts.

In the solution worked out, the stresses are separated. The screw segment itself assumes the task of transmitting the torque. For this purpose, a new connecting element is inserted which is connected to at least two screw segments and which assumes the task of transmitting the torque of one screw segment to the next one. This means that the torque transmitted between the segments is no longer transmitted via the screw mandrel. The screw mandrel remains without torque stress. In the science of the strength of materials, one speaks of a separation between torsional stress and direct stress. The novel screw mandrel (tension rod) has a smaller diameter and is “smooth” on the outside. The notch factor is therefore close to “1”, which again increases the permissible stress in the segment area.

One possible embodiment is the use of several flat rods which are distributed over the circumference of the tension rod.

An argument for a large radial extension is that the number can be minimized and that the functionality “transmission of torsion” is guaranteed.

One advantage of the disclosure is the simplicity of the solution how the torque is transmitted via an additional connecting element and how the transmission of stresses is distributed over different components. This solution is very inexpensive because the connecting elements are commercially available as rod material (bulk goods).

It is explicitly pointed out that the subject matter of the second aspect can advantageously be combined with the subject matter of the first aspect of the disclosure, either individually or in a cumulative manner in any combination.

In a third aspect of the disclosure, the task is solved by a screw to be used in an extruder, the screw having a mandrel and a plurality of segments borne on the mandrel and arranged axially with respect to one another, wherein a segment border between a first segment and an axially adjacent second segment has a first separate connecting element and a second separate connecting element with a different geometry, a connecting element being adapted to transmit a torque over the segment border.

A “screw root” is understood as the inner contact surface, seen radially, between the material to be processed and the screw. It can designate the bottom of a screw segment or the outer diameter of the screw mandrel.

Other than in the second aspect of the disclosure, it is proposed here, to put it simply, to insert two connecting elements with different geometries in the segment border between two segments.

It is conceivable, for instance, to position both a round connecting element and an angular connecting element at the same segment border.

Advantageously, it can be achieved in this manner that various connecting elements are combined such that depending on the position of the connecting element with respect to the position of the web on the screw, different conditions can be fulfilled.

In a specific example of a particularly advantageous embodiment, it is conceivable to position connecting elements with a short axial extension, especially balls, at the height of the webs at the segment border, also outside the screw root; whereas angular connecting elements with a larger axial extension are positioned on a pitch circle with a smaller radius.

It is explicitly pointed out that the subject matter of the third aspect can advantageously be combined with the subject matter of the first aspect of the disclosure, either individually or in a cumulative manner in any combination.

The connecting element preferably extends in the axial direction of the screw throughout a segment, and the connecting element is adapted to transmit the torque also to a third and/or to a more remote segment.

Advantageously, in this manner, the assembly of the connecting elements can be simplified.

In a fourth aspect of the disclosure, the task is solved by a screw to be used in an extruder, the screw having a mandrel and a plurality of segments borne by the mandrel and arranged axially with respect to one another, a segment border between a first segment and an axially adjacent second segment having a separate round connecting element or a connecting element with round edges, the connecting element extending in the axial direction of the screw throughout a segment and being adapted to transmit a torque over the segment border to a segment which is adjacent and/or next to an adjacent segment, and/or to a segment which is even more remote.

A connecting element with “round edges” is a connecting element which has rounded edges. Such a connecting element can be produced, for instance, by rounding the edges of an angular connecting element.

Other than is common in the state of the art, it is proposed here to use connecting elements which have a circular cross-section with reference to the axis of the extruder, in particular round rods, or connecting elements with rounded edges.

In an advantageous embodiment, one example of a connecting element with rounded edges can be a kind of a TORX®.

Advantageously, it can be achieved in this manner that less pronounced notch effects occur in the environment of the connecting element, leading to a better material utilization.

It is explicitly pointed out that the subject matter of the fourth aspect can advantageously be combined with the subject matter of the above aspects of the disclosure, either individually or in a cumulative manner in any combination.

Optionally, the connecting element is dimensioned such that a critical torque for connecting the segments by the connecting element is lower than a critical torque for one segment.

A “critical torque” is a torque which causes a lasting damage in one of the components.

Advantageously, it can be achieved in this manner that the occurrence of a critical torque does not cause a damage of the screw segment, but that the connecting elements are damaged instead, which can make repair less expensive.

Preferably, the connecting element is a hollow body.

The connecting element can be, for instance, a sleeve.

Advantageously, it can be achieved in this manner that connecting elements can be additionally secured in the axial direction, in particular by means of a screw which extends through the cavity of the connecting element.

Preferably, the connecting element includes a different material than the segments, in particular spring steel.

Thus, it is for instance conceivable to adapt the connecting elements to a different load than the segments. In a theoretical case, the connecting elements are subjected almost exclusively to shearing loads so that often materials can be used which are better from a mechanical viewpoint than the ones used for the flanks of the segment spirals, which have to withstand many different kinds of loads.

Preferably, the connecting element is made of a different material than the mandrel.

This also helps to take into account the actual loads to be expected when the screw is constructed. In case of an ideal construction, the mandrel would substantially have to bear the axial tensile force as well as superimposed flexural fatigue stresses. The axial force is produced when the segments are braced for sealing of the segment borders. In addition, the mandrel will normally have to bear the bending moment caused by the dead weight of the segments and by its own dead weight, as soon as the direction of extension of the extruder deviates from the vertical. However, the effects of dead weight will normally be minor in comparison to the bracing force.

Preferably, the connecting element is arranged radially outside the mandrel.

Advantageously, in this manner, geometrical design of the mandrel can be greatly facilitated.

Preferably, the connecting element is arranged radially inside the segments.

Advantageously, in this manner, geometrical design of the mandrel can be greatly facilitated and a high material utilization of the mandrel can be achieved.

Preferably, the connecting element has an axial play between the segments.

Advantageously, in this manner, a double fit during axial bracing of the segments can be avoided. Further, the risk of leaky segment borders is reduced.

Preferably, the connecting element extends through the segments with no play, especially in the circumferential direction of the segments.

Advantageously, in this manner, it can be achieved that no strong notch effects are produced between the connecting element and the segments proximate to the segment border.

Preferably, the connecting element has a line contact with the mandrel in the axial direction of the screw.

Advantageously, in this manner, the design of the segments as well as production of the segments can be simplified. In this advantageous embodiment, the segments can have a groove in which the connecting element is inserted. This very simple solution is, in particular, very inexpensive.

Preferably, the connecting element has a circular recess facing the mandrel.

Advantageously, in this manner, the connecting element can fit even better in the groove which is provided in the segments for this purpose.

Preferably, the mandrel has a notch factor within the range between 1 and 1.2, preferably in the range between 1 and 1.05 and especially preferably in the range between 1 and 1.01.

Ideally, the segments of the mandrel have a circular cross-section. The notch factor β will in the ideal case be 1. The more circular and the smoother the cross-section of the mandrel, the better the possible utilization of material will be.

It is explicitly pointed out that the above-mentioned range limits of the notch factor for the mandrel are not to be understood as strict limits but can be higher or lower than indicated, on an engineering scale, without leaving the described aspect of the disclosure. In other words, the range limits are intended to form points of reference for the embodiment of the mandrel proposed here.

Preferably, the segments of the mandrel have a circular cross-section.

Advantageously, in this manner, the mandrel can be manufactured very inexpensively and can be obtained at low cost. Further, this mandrel design leads to a very good possible material utilization of the mandrel.

Preferably, the cross-section of the mandrel is circular, in particular over its entire longitudinal extension axially within the segments.

Advantageously, in this manner, the mandrel can be manufactured very inexpensively and can be obtained at low cost. Further, this particularly advantageous mandrel embodiment leads to a very good possible material utilization of the mandrel.

Preferably, the segments have a circular recess facing the mandrel.

Advantageously, in this manner, the segments can allow a positive engagement with a circular mandrel. This embodiment is particularly inexpensive and can lead to a high possible material utilization.

Preferably, the segments have a close sliding fit with respect to the mandrel.

A “close sliding fit” is a firm fit where, however, the parts are not wedged together. An explanation of the term “close sliding fit” can be found, for instance, in: Lueger, Otto: Lexikon der gesamten Technik and ihrer Hilfswissenschaften, Vol. 7, Stuttgart, Leipzig 1909, page 47.

Advantageously, in this manner, the segments can be mounted very easily on the mandrel.

Preferably, the segments, that is, at least one segment, in particular, all but one, can rotate freely about the mandrel.

Advantageously, in this manner, a clear separation of functions between the segments and the mandrel can be achieved and the construction causes no double fit.

Preferably, the segments, the mandrel and the connecting element are adapted for transmitting at least 70%, in particular 80%, 90% or 100%, of a torque from one segment to the next by means of the connecting element.

In any case, the disclosure is to be regarded as implemented if the segments, the mandrel and the connecting elements are matched such that at least 70% of a torque, in particular at least 80%, 90% or, especially preferably, even 100% are transmitted from one segment to the other by means of (a) connecting element(s).

It is explicitly pointed out that the above-mentioned values for torque transmission are not to be understood as strict limits but can be higher or lower than indicated, on an engineering scale, without leaving the described aspect of the disclosure. In other words, the values are intended to form points of reference for the size of the connecting elements proposed here.

In a fifth aspect of the disclosure, the task is solved by a screw to be used in an extruder, the screw having a mandrel and a plurality of segments borne by the mandrel and arranged axially with respect to one another, with a segment border between a first segment and an axially adjacent second segment having a separate cylindrical connecting element adapted to transmit a torque over the segment border, where a length of a first segment differs from the length of a second segment.

Thus, the length of any segment of the screw can differ from that of the other segments.

It is also conceivable that each segment has a different length. Advantageously, in this manner, the flexibility in configuring the screw can be increased. Thus, a screw can have different zones of different lengths.

Optionally, a segment at one end of the screw is longer than another one, in particular twice as long or three times as long.

Advantageously, in this manner, a first segment of the screw which is connected to the drive or which bears the screw mandrel can be constructed differently from the other segments and can be adapted to the specific requirements made on a segment at the screw end without losing the advantages of the present disclosure.

It is explicitly pointed out that the subject matter of the fifth aspect can advantageously be combined with the subject matter of the preceding aspects of the disclosure, either individually or in a cumulative manner in any combination.

In a sixth aspect of the disclosure, the task is solved by an extruder in which a screw proposed here is used.

It is understood that the advantages of a screw as described above extend directly to an extruder, in particular a single-screw extruder or a multiple-screw extruder having a screw as described above.

It is explicitly pointed out that the subject matter of the sixth aspect can advantageously be combined with the subject matter of the preceding aspects of the disclosure, either individually or in a cumulative manner in any combination.

### BRIEF DESCRIPTION OF THE DRAWINGS

In the following, the disclosure is explained in more detail by means of two examples of embodiment with reference to the drawings, wherein

FIG. 1 schematically shows a section of an extruder screw, the extruder screw having a mandrel and a plurality of segments borne by the mandrel and arranged axially with respect to one another, with a segment border between a first segment and an axially adjacent second segment having a separate angular connecting element adapted to transmit a torque over the segment border, wherein in the assembled state a radial extension of the connecting element is larger than or equal to an extension in the circumferential direction;

FIG. 2 schematically shows a section of an alternative extruder screw, the extruder screw having a mandrel and a plurality of segments borne by the mandrel and arranged axially with respect to one another, a segment border between a first segment and an axially adjacent second segment having a separate round connecting element, the connecting element extending throughout a segment in the axial direction of the screw and being adapted to transmit a torque over the segment border to an adjacent segment and/or to a segment next to the latter and/or to a segment more remote;

FIG. 3 schematically shows a section of an alternative extruder screw comprising several segments, in particular having a first and a last segment connected by connecting elements, and

FIG. 4 schematically shows a section through the alternative extruder screw from FIG. 3.

### DETAILED DESCRIPTION OF THE DRAWINGS

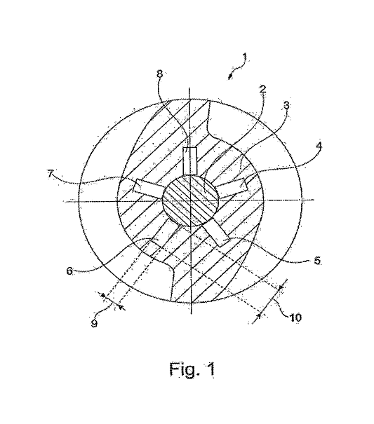

The extruder screw 1 in FIG. 1 has a mandrel 2 and a plurality of screw segments 3 borne by the mandrel and arranged axially with respect to one another (the screw segment 3 is shown in a section perpendicular to the axis of the extruder directly adjacent to the segment border).

At the border between a first screw segment 3 and an axially adjacent second segment (masked in FIG. 1), the extruder screw has several separate angular connecting elements 4, 5, 6, 7, 8. The connecting elements 4, 5, 6, 7, 8 are adapted to transmit a torque over the segment border.

In their assembled state, a radial extension 10 of the connecting elements 4, 5, 6, 7, 8 is larger than or equal to an extension 9 in the circumferential direction.

Recesses (not referenced individually) in the screw segment 3 have a contour which is at least substantially identical with the contour of the connecting elements 4, 5, 6, 7, 8. The recesses are open in the direction of the segment axis (not referenced), that is, in the threaded state, open towards the mandrel 2, so that all connecting elements 4, 5, 6, 7, 8 can be removed from and inserted in the recesses axially and/or radially.

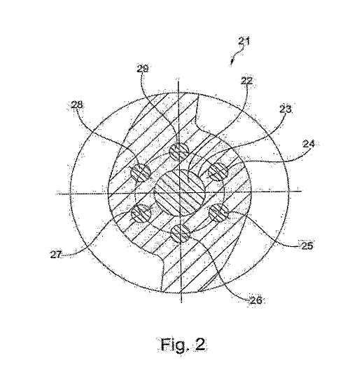

The alternative extruder screw 21 in FIG. 2 has a mandrel 22 and a plurality of segments 23 borne by the mandrel and arranged axially with respect to one another (in a section perpendicular to the axis of the extruder, a segment is shown directly adjacent to the segment border).

At the border between the segment 23 and an axially adjacent second segment (not shown), the alternative extruder screw 21 has several separate circular connecting elements 24, 25, 26, 27, 28, 29.

The connecting elements 24, 25, 26, 27, 28, 29 extend in the axial direction of the screw throughout a segment.

The connecting elements 24, 25, 26, 27, 28, 29 are adapted to transmit a torque over the segment border to an adjacent segment and/or a segment next to the adjacent segment and/or to an even more remote segment.

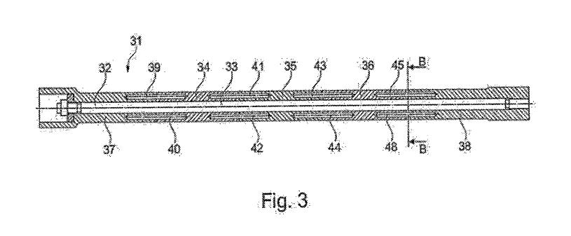

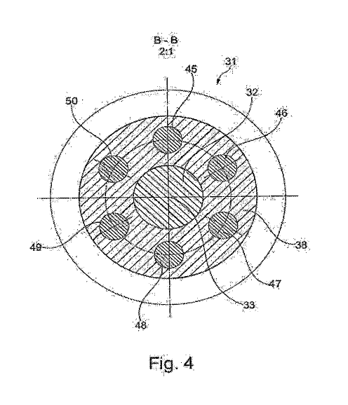

The alternative extruder screw 31 in FIGS. 3 and 4 has a mandrel 32 with an axis 33. For purposes of clarity, the spirals of the extruder screw are not shown. There is shown the screw root of the alternative extruder screw.

The alternative extruder screw 31 has several segments 34, 35, 36, 37, 38 borne by the mandrel 32 and arranged axially with respect to one another.

A first screw segment 37 and a last screw segment 38 have a configuration different from that of the other screw segments 34, 35, 36.

At the border between the screw segments 34, 35, 36, 37, 38, the extruder screw has a plurality of connecting elements 39, 40, 41, 42, 43, 44, 45, 46, 47, 48, 49, 50.

The connection between adjacent segments is always configured according to the same scheme. By way of example, the connection between the last segment 38 and the adjacent segment 36 is examined more closely here and is represented in FIG. 4 by a section through the last segment 38.

The connecting elements 45, 46, 47, 48, 49, 50 are shown which are arranged on a pitch circle within the segments 36, 38.

The connecting elements 39, 40, 41, 42, 43, 44, 45, 46, 47, 48, 49, 50 are inserted with positive engagement in blind holes (not shown here for purposes of clarity).

1. A screw to be used in an extruder comprises a mandrel and a plurality of segments borne by the mandrel and arranged axially with respect to one another, a segment border between a first segment and an axially adjacent second segment having a separate cylindrical connecting element adapted to transmit a torque over the segment border,
wherein
the ratio of a length of the connecting element to the diameter of the connecting element is higher than 11.

2. The screw according to claim 1, wherein the segment has a blind hole, with the connecting element being positioned in the blind hole with positive engagement.

3. The screw according to claim 1, wherein the ratio of the diameter of the screw root to the diameter of the connecting element lies within a range between 4 and 9.

4. The screw according to claim 1 further including an axially adjacent second segment having a separate angular connecting element adapted to transmit a torque over the segment border,
wherein
in the assembled state, a radial extension of the connecting element is larger than or equal to an extension in the circumferential direction.

5. The screw according to claim 1
wherein
a segment border between a first segment and an axially adjacent second segment has a first separate connecting element and a second separate connecting element with a different geometry,
wherein a connecting element is adapted to transmit a torque over the segment border.

6. The screw according to claim 1, wherein in the axial direction of the screw, the connecting element extends throughout a segment and the connecting element is adapted to transmit the torque also to a third and/or to an even more remote segment.

7. The screw according to claim 1, further including an axially adjacent second segment having a separate round connecting element or a connecting element with round edges,
wherein
the connecting element extends in the axial direction of the screw throughout a segment and is adapted to transmit a torque over the segment border to an adjacent segment and/or a segment next to the latter and/or to a segment even more remote.

8. The screw according to claim 1, wherein the connecting element is dimensioned such that a critical torque for connecting the segments by the connecting element is lower than a critical torque for one segment.

9. The screw according to claim 1, wherein the connecting element is a hollow body.

10. The screw according to claim 1, wherein the connecting element has a different material than the segments.

11. The screw according to claim 1, wherein the connecting element has a different material than the mandrel.

12. The screw according to claim 1, wherein the connecting element is arranged radially outside of the mandrel.

13. The screw according to claim 1, wherein the connecting element is arranged radially within the segments.

14. The screw according to claim 1, wherein the connecting element has an axial play between the segments.

15. The screw according to claim 1, wherein the connecting element extends through the segments free of clearance, in particular in the circumferential direction of the segments.

16. The screw according to claim 1, wherein the connecting element has a line contact with the mandrel in the axial direction of the screw.

17. The screw according to claim 1, wherein the connecting element has a circular recess facing the mandrel.

18. The screw according to claim 1, wherein the mandrel has a notch factor within the range between 1 and 1.2.

19. The screw according to claim 1, wherein the mandrel has a circular cross-section within the segments.

20. The screw according to claim 1, wherein the mandrel has a circular cross-section.

21. The screw according to claim 1, wherein the segments have a circular recess facing the mandrel.

22. The screw according to claim 1, wherein the segments have a close sliding fit with respect to the mandrel.

23. The screw according to claim 1, wherein the segments, at least one segment, in particular all but one, are designed so that they can rotate freely about the mandrel.

24. The screw according to claim 1, wherein the segments, the mandrel and the connecting element are adapted for transmitting at least 70%, in particular 80%, 90% or 100%, of a torque from one segment to the next via the connecting element.

25. The screw according to claim 1 having an axially adjacent second segment having a separate cylindrical connecting element adapted to transmit a torque over the segment border,
wherein
a length of a first segment is different from the length of a second segment.

26. The screw according to claim 25, wherein a segment at one end of the screw is longer than another segment.

27. An extruder having a screw according to claim 1.

28. A plant for manufacturing a product from thermoplastic, the plant having an extruder according to claim 27.
